(19) United States
(12) Patent Application Publication
(10) Pub. No.: US 2025/0306601 A1
(43) Pub. Date: Oct. 2, 2025

(54) Use Projected Guidance Line for Future Operations

(71) Applicant: Ag Leader Technology, Inc., Ames, IA (US)

(72) Inventors: Josue Calderon, Apex, NC (US); Trent Anagnostopoulos, Ankeny, IA (US)

(73) Assignee: Ag Leader Technology, Inc., Ames, IA (US)

(21) Appl. No.: 19/094,360

(22) Filed: Mar. 28, 2025

Related U.S. Application Data
(60) Provisional application No. 63/571,956, filed on Mar. 29, 2024.

(51) Int. Cl. G05D 1/646; G05D 1/248; G05D 107/20; G05D 109/20; G05D 111/10; G05D 111/50; G06V 20/10; G06V 20/17

(52) U.S. Cl. CPC G05D 1/646; G05D 1/248; G06V 20/17; G06V 20/188; G05D 2107/21; G05D 2109/20; G05D 2111/10; G05D 2111/52

(57) ABSTRACT

Methods and systems for generating agricultural guidance data provide for determining a position and orientation of an agricultural vehicle in a field using at least one positioning sensor. Locations of crop rows in the field relative to the agricultural vehicle are determined using at least one crop detection sensor. Navigation space coordinates of points associated with the crop rows are calculated by combining the position and orientation of the agricultural vehicle with the locations associated with the crop rows in the field relative to the agricultural vehicle. Guidance data is generated based on the calculated navigation space coordinates and stored for use in a subsequent agricultural operation.

### PRIORITY STATEMENT

This application claims priority to provisional application No. 63/571,956 filed on Mar. 29, 2024, and entitled “Use Projected Guidance Line for Future Operations” which is hereby incorporated by reference in its entirety.

### FIELD OF THE INVENTION

The present invention generally relates to agricultural guidance lines. More particularly, but not exclusively, the present invention relates to using projected guidance lines for future agricultural operations.

### BACKGROUND

When driving any ground-based vehicle wherein both the front and rear wheels do not simultaneously turn, the front wheels follow a different path than the rear wheels when steering around any curve. This is shown in FIG. 1 with a vehicle 10 showing a first path 12 for the front wheels and a second path 14 for the rear wheels. The difference in the two paths is dependent on various factors including, but not limited to, the vehicle's geometry (such as wheelbase) and traveling speed.

Similarly, as shown in FIG. 2, if a vehicle 10 is towing an implement 16 (e.g. a truck towing a trailer or a tractor pulling a planting implement) along a curved path, the second path 14, in this instance the path of the towed implement 16 will not coincide with the first path 12 of the towing vehicle 10.

Furthermore, as shown in FIG. 3, if the vehicle 10 is traveling alongside a slope, the implement 16 will often tend to slide down the slope due to the effects of gravity causing the second path 14 of the implement 16 to deviate from the first path 12 of the towing vehicle 10 even more.

This discrepancy between the path of the vehicle and the path of the pulled implement can cause issues for farmers. For example, crops planted by the implement pulled by a vehicle, where the vehicle is following a guidance line, would not be planted along the expected path. As such, when coming back with a follow up operation later in the season the guidance line used to plant the crops may not be usable for subsequent operations.

If the position of the planter was known and recorded as a guidance line at the time of planting, then follow-up operations could rely on that guidance line for the purposes of steering. However, if the position of the planter was not recorded, was unknown, or was insufficiently reliable to be used for steering, then subsequent operations would have to rely on some other method for autonomous steering.

Presently, there are various solutions available for farmers that do not have a guidance line based on the position of the planter, at the time of planting, available to them for subsequent field operations such as cultivation, application of fertilizer, application of pesticides, or harvest. Each of these operations requires a different set of sensors, for the purposes of autonomous steering, depending on the vehicle in use (e.g. sprayer or combine) and the stage of the crops (e.g. pre-canopy or post-canopy). For example, steering a sprayer between rows of early season corn (i.e. pre-canopy) is often performed manually but recent advancements have allowed several agricultural companies to provide automatic steering solutions based on camera systems where the difference between the vegetation and the dirt in the lane between rows is identified and used to steer the vehicle. Examples of these systems include John Deer's Auto-Trac Vision and Raven's VSN Visual Guidance systems. Other methods are continually being developed, such as those discussed in U.S. patent application Ser. No. 19/041,825, filed Jan. 30, 2025, and entitled “Visual Detection of Crop Rows”, hereby incorporated by reference in its entirety. However, these methods tend to fail once the crop has canopied, and the ground is no longer visible between rows. As such, autonomous steering of a sprayer for the purpose of application of fertilizer or pesticide, after the crop has canopied, can no longer rely on a vision system (at least as currently known to be commercially available). Various companies sell a variety of contact and non-contact sensors that are mounted below the crop canopy and that can identify the lateral distance from the vehicle's wheels to corn stalks on either side of the wheels. Using these distances, the vehicle can automatically center itself between the rows of crops (e.g. John Deer's RowSense for sprayers). Finally, for harvest, neither the vision based solutions nor sub-canopy methods that work for sprayers are viable. As such several companies provide physical contact sensors that attach to the head of a combine, and which can be used (similarly to the post-canopy sprayer steering solutions) to maintain the combine centered on the crop rows (e.g. Headsight's TrueSense system).

So, at present, there are various methods which can be used to automatically steer between crop rows when a guidance line based on the planter's position is unavailable. However, each operation requires its own sensor suite and its own controls system to interpret the different sensor inputs. There is no known way, to date, to utilize the data from one operation to improve the steering performance of subsequent operations, let alone to provide a full guidance line thereby removing the necessity for additional sensor suites for future operations. Any solution that would allow for one operation (e.g. cultivation or application of fertilizer in pre-canopy corn) to provide a guidance line for future operations (e.g. post-canopy spraying or harvest) would constitute a significant improvement over the current state-of-the-art systems and provide a significant cost savings for farmers.

Therefore, what are needed are new and improved systems and methods to use data from one operation to improve the steering performance of subsequent operations and thereby reduce reliance on use of sensors for future operations.

### SUMMARY

Therefore, it is a primary object, feature, or advantage of the present disclosure to improve over the state of the art.

It is a further object, feature, or advantage of the present disclosure to generate accurate guidance lines based on actual crop positions rather than theoretical planting paths.

It is a still further object, feature, or advantage of the present disclosure to provide a unified guidance system that works across multiple agricultural operations throughout a growing season.

Another object, feature, or advantage is to transform sensor data from early-season operations into persistent navigational guidance for later operations.

Yet another object, feature, or advantage is to create a system for recording and storing georeferenced crop row positions in a reusable format.

A further object, feature, or advantage is to integrate multiple positioning technologies including global positioning system (GPS), inertial measurement unit (IMU) systems, and vision systems to determine precise crop row locations.

Yet a further object, feature, or advantage is to calculate and store mathematical offsets between original guidance lines and actual crop positions.

Another object, feature, or advantage is to enable the projection of camera-identified crop rows into navigation space coordinates.

Still another object, feature, or advantage is to provide a dual-use mechanism that simultaneously performs agricultural operations and mapping functions.

A further object, feature, or advantage is to establish a methodology for converting cross-track error measurements into absolute position coordinates.

Yet another object, feature, or advantage is to implement a sensor fusion system that combines vehicle pose data with crop position detection.

Still a further object, feature, or advantage is to create a data structure for storing and

retrieving field-specific guidance information across multiple implements and operations.

Another object, feature, or advantage is to provide a computational framework for real-time guidance line generation during field operations.

Yet another object, feature, or advantage is to develop a method for translating relative sensor measurements into navigation space coordinates.

A further object, feature, or advantage is to establish a standardized format for guidance data that can be transferred between different agricultural vehicles and implements.

Still another object, feature, or advantage is to implement algorithms for detecting and mapping the center points of crop rows using various sensing technologies.

It is a further object, feature, or advantage of the present disclosure to reduce the need for multiple specialized sensor suites for different agricultural operations.

It is a still further object, feature, or advantage of the present disclosure to improve steering repeatability across multiple field operations throughout a growing season.

Another object, feature, or advantage is to reduce equipment costs for farmers by eliminating redundant guidance systems.

Yet another object, feature, or advantage is to enable reliable autonomous steering in post-canopy operations when visual identification of rows is difficult or impossible.

A further object, feature, or advantage is to provide consistent guidance even when crops have been damaged by weather events.

Yet a further object, feature, or advantage is to enhance the precision of follow-up operations by utilizing actual crop positions rather than planned positions.

Another object, feature, or advantage is to minimize crop damage during field operations through more accurate row navigation.

Still another object, feature, or advantage is to reduce operator fatigue by automating steering based on previously generated guidance lines.

A further object, feature, or advantage is to extend the utility of existing guidance systems by incorporating real-time crop position data.

Yet another object, feature, or advantage is to provide custom applicators with the ability to share guidance data with farmers for subsequent operations.

Still a further object, feature, or advantage is to avoid issues associated with contact-based guidance systems such as mechanical wear and tear.

Another object, feature, or advantage is to improve fuel efficiency through optimized path planning based on actual crop positions.

Yet another object, feature, or advantage is to enable smaller autonomous vehicles to generate guidance data for use by larger equipment.

A further object, feature, or advantage is to increase operational efficiency by eliminating the need to recalibrate guidance systems between different field operations.

Still another object, feature, or advantage is to enable autonomous navigation in conditions where traditional sensors may fail, such as low light or adverse weather.

One or more of these and/or other objects, features, or advantages of the present disclosure will become apparent from the specification and claims that follow. No single embodiment need provide each and every object, feature, or advantage. Different embodiments may have different objects, features, or advantages. Therefore, the present disclosure is not to be limited to or by any objects, features, or advantages stated herein.

According to one aspect, a method for generating agricultural guidance data may include determining a position and orientation of an agricultural vehicle in a field using at least one positioning sensor and determining locations of crop rows in the field relative to the agricultural vehicle using at least one crop detection sensor. The method may further include calculating navigation space coordinates of points along the crop rows by combining the position and orientation of the agricultural vehicle with the relative locations of the crop rows. Additionally, the method may include generating guidance data based on the calculated navigation space coordinates and storing the guidance data for use in a subsequent agricultural operation. The agricultural vehicle may be an unmanned aerial vehicle (UAV) flying over the field, wherein the at least one crop detection sensor may include at least one camera mounted on the UAV capturing image data of the field to identify the locations of crop rows.

According to another aspect, a method for providing guidance data between agricultural operations may include receiving an original guidance line used during planting of crops in a field. During a first agricultural operation after planting, the method may include determining a position and orientation of a first agricultural vehicle, detecting actual positions of crop rows using at least one sensor mounted on the first agricultural vehicle, calculating a series of offset values representing differences between the detected actual positions of crop rows and the original guidance line, and storing the original guidance line and the series of offset values. During a second agricultural operation, the method may include retrieving the original guidance line and the series of offset values and guiding a second agricultural vehicle based on a combination of the original guidance line and the series of offset values.

According to a further aspect, a system for generating agricultural guidance data may include at least one positioning sensor mounted on an agricultural vehicle and configured to determine a position and orientation of the agricultural vehicle and at least one crop detection sensor mounted on the agricultural vehicle and configured to detect positions of crop rows relative to the agricultural vehicle. The system may further include a processing system communicatively coupled to the at least one positioning sensor and the at least one crop detection sensor. The processing system may be configured to receive position and orientation data from the at least one positioning sensor, receive crop row position data from the at least one crop detection sensor, calculate navigation space coordinates of points along the crop rows by combining the position and orientation data with the crop row position data, generate guidance data based on the calculated navigation space coordinates, and store the guidance data in a storage device. The system may also include an automatic steering system configured to guide an agricultural vehicle during a subsequent agricultural operation using the stored guidance data.

According to yet another aspect, a method for generating agricultural guidance data using aerial imagery may include flying an unmanned aerial vehicle (UAV) over a field containing planted crops and capturing image data of the field using at least one camera mounted on the UAV. The method may further include determining positions and orientations of the UAV corresponding to the captured image data and processing the image data to identify locations of crop rows. Additionally, the method may include calculating navigation space coordinates of the identified crop rows by combining the positions and orientations of the UAV with the identified locations of crop rows in the image data, generating guidance data based on the calculated navigation space coordinates, and providing the guidance data to an automatic steering system of a ground-based agricultural vehicle for use during a subsequent agricultural operation.

According to another aspect, a non-transitory computer-readable medium storing instructions may cause a processor to perform operations when executed. The operations may include receiving position and orientation data from at least one positioning sensor mounted on an agricultural vehicle and receiving crop row detection data from at least one crop detection sensor mounted on the agricultural vehicle. The operations may further include calculating navigation space coordinates of points along crop rows by combining the position and orientation data with the crop row detection data and comparing the calculated navigation space coordinates with an original guidance line used during planting. Additionally, the operations may include generating guidance adjustment data representing differences between the original guidance line and the calculated navigation space coordinates, storing the guidance adjustment data in association with the original guidance line, and providing the guidance adjustment data and the original guidance line to an automatic steering system for use during a subsequent agricultural operation.

According to another aspect, a method for generating a guidance line for agricultural operations includes determining a vehicle pose of an agricultural vehicle in a field using position sensors and detecting positions of crop rows in the field relative to the agricultural vehicle using one or more detection sensors. The method may further include calculating a series of points representing centers of lanes between the crop rows based on the vehicle pose and the detected positions of crop rows. Additionally, the method may include converting the series of points into a guidance line represented in a geographic coordinate system and storing the guidance line for use in subsequent agricultural operations.

According to another aspect, a system for generating and utilizing agricultural guidance lines includes a position determination subsystem mounted on an agricultural vehicle and configured to determine a pose of the agricultural vehicle. The system may also include a crop row detection subsystem configured to detect positions of crop rows relative to the agricultural vehicle. Additionally, the system may include a processing subsystem configured to calculate a series of points representing centers of lanes between the crop rows based on the vehicle pose and the detected positions of crop rows, convert the series of points into a guidance line represented in a geographic coordinate system, and store the guidance line in a storage subsystem. The system may further include a guidance subsystem configured to retrieve the stored guidance line and control steering of the agricultural vehicle or a different agricultural vehicle during a subsequent agricultural operation.

According to a further aspect, a method for providing consistent guidance across multiple agricultural operations includes performing a first agricultural operation in a field using a first agricultural vehicle. During the first agricultural operation, the method may include determining a vehicle pose of the first agricultural vehicle, detecting positions of crop rows relative to the first agricultural vehicle using one or more detection sensors, calculating a guidance line representing centers of lanes between crop rows based on the vehicle pose and the detected positions of crop rows, and storing the guidance line in a storage medium. The method may further include performing a second agricultural operation in the field using a second agricultural vehicle. During the second agricultural operation, the method may include retrieving the stored guidance line and automatically steering the second agricultural vehicle based on the retrieved guidance line.

According to yet another aspect, a method for creating reusable guidance lines for agricultural operations may include retrieving an original guidance line used during planting of crops in a field and performing an agricultural operation in the field. During the agricultural operation, the method may include determining a vehicle pose of an agricultural vehicle, detecting positions of crop rows relative to the agricultural vehicle, calculating offset values representing differences between detected positions of crop rows and the original guidance line, and storing the original guidance line and the offset values. The method may further include, during a subsequent agricultural operation, retrieving the original guidance line and the offset values and automatically steering an agricultural vehicle based on the original guidance line as adjusted by the offset values.

According to still another aspect, a system for mapping crop rows may include an autonomous vehicle configured to traverse a field, a position determination subsystem mounted on the autonomous vehicle and configured to determine a pose of the autonomous vehicle, and a crop row detection subsystem mounted on the autonomous vehicle and configured to detect positions of crop rows relative to the autonomous vehicle. The system may also include a processing subsystem configured to calculate a guidance line representing centers of lanes between crop rows based on the vehicle pose and the detected positions of crop rows and store the guidance line for use in subsequent agricultural operations performed by other agricultural vehicles.

According to another aspect, a non-transitory computer-readable medium storing instructions to cause a processor to perform a method when executed. The method may include receiving position data from positioning sensors mounted on an agricultural vehicle indicating a pose of the agricultural vehicle in a field and receiving detection data from crop row detection sensors indicating positions of crop rows relative to the agricultural vehicle. The method may further include calculating a guidance line representing centers of lanes between crop rows based on the position data and the detection data, storing the guidance line in a storage medium, and transmitting the guidance line to a guidance system of a subsequent agricultural vehicle for use during a subsequent agricultural operation.

### BRIEF DESCRIPTION OF THE DRAWINGS

Illustrated embodiments of the disclosure are described in detail below with reference to the attached drawing figures, which are incorporated by reference herein.

FIG. 1 is a diagram illustrating the path taken by the front wheels (solid line) of a front wheel steer vehicle as compared to the path followed by the rear wheels (dotted line).

FIG. 2 is a diagram illustrating the path taken by a vehicle (solid line) compared to the path of a trailer being towed by the vehicle (dotted line).

FIG. 3 is a diagram illustrating the path taken by a vehicle (solid line) compared to the path of a trailer being towed by the vehicle (dotted line) when driving along a slope.

FIG. 4 is a diagram illustrating a guidance line generated based on known vehicle location and sensor data.

FIG. 5 is a diagram illustrating a guidance line generated between rows of corn using data from a camera mounted on a tractor.

FIG. 6 is a diagram illustrating a GPS unit and stereographic depth camera mounted on an agricultural sprayer.

FIG. 7 is a diagram illustrating a guidance line generated between two rows of corn using sensor data.

FIG. 8 is a diagram illustrating an agricultural vehicle using mechanical row feelers that is steering slightly off from the center of the lane between crop rows.

FIG. 9 is a diagram illustrating an unmanned aerial vehicle (UAV) flying over rows of soybeans to collect crop position data.

FIG. 10A and FIG. 10B are pictorial representations of different vehicles for collecting and storing the location of lanes between crop rows for use as guidance lines in future agricultural operations.

FIG. 11 is a flow chart illustrating one example of a method for generating guidance data.

FIG. 12 is a block diagram illustrating one example of a system.

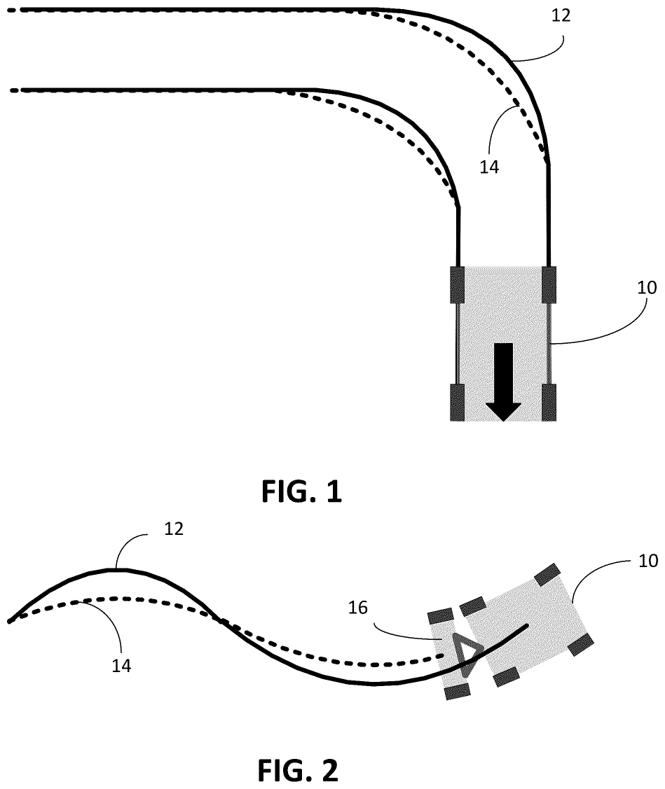

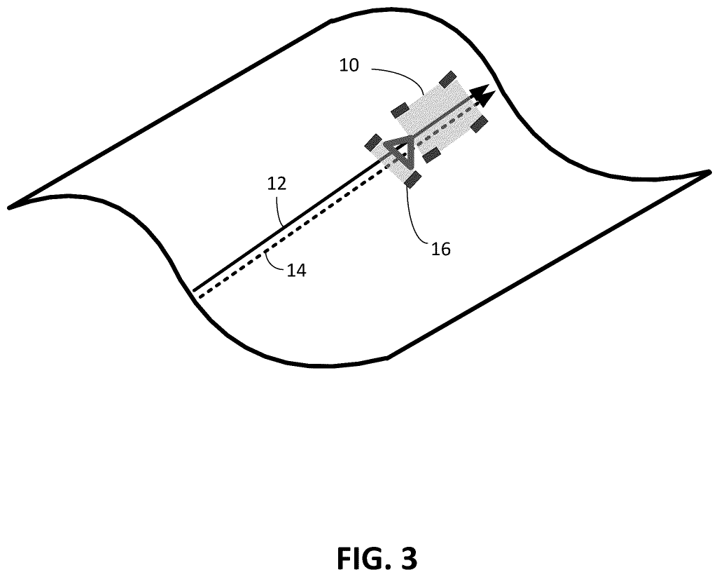

### DETAILED DESCRIPTION

The present disclosure provides for new field operations be run or current/planned field operations be augmented in such a way as to allow for a guidance line to be generated based on the positions of the crops. This allows future operations to be conducted along the new guidance line without needing additional sensor suites of their own, thereby reducing overall expense and improving steering repeatability.

In one embodiment, anytime that the location of the planter was not recorded as a guidance line or the guidance line is unreliable enough to prevent it from being used for steering during subsequent field operations, that operations being run in the field should be utilized to provide a guidance line for future operations, whenever feasible. As will be discussed, this should be the case either when the original field operation can be augmented to include the guidance line generation or during a field operation specifically designed to generate a guidance line.

Doing so may use the position, and also preferably the orientation (referred to herein as “pose”) of the vehicle be known. The vehicle pose may be calculated using a combination of sensors including, but not limited to a GPS and/or an IMU. Other sensors may include, without limitation, wheel angle sensors, cameras, and LIDAR units.

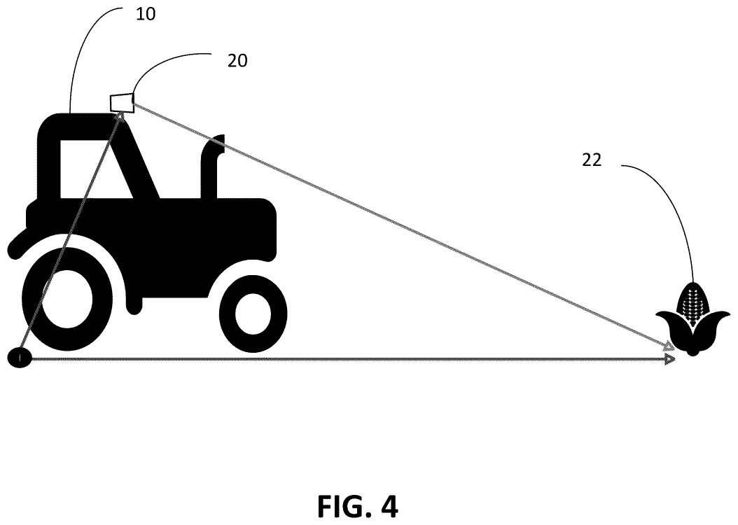

Once the position of the vehicle is known and the location of the center of a lane between rows of crops is calculated relative to the location of the vehicle, then the location of a point that may be used to generate a guidance line can be calculated as discussed in U.S. patent application Ser. No. 19/057,707, filed Feb. 19, 2025, and entitled, “Projecting Pixels onto Terrain” and U.S. patent application Ser. No. 19/041,825, filed Jan. 30, 2025, and entitled “Visual Detection of Crop Rows” (both of which are hereby incorporated by reference) and as depicted in FIG. 4. In FIG. 4 the vehicle 10 has a camera 20 pointed towards a plant 22 to capture imagery for use in visually detecting crop rows.

Note that the center of the crops rows (or the lanes between crop rows) may be found using a variety of methods, including but not limited to those discussed in U.S. patent application Ser. No. 19/041,825, filed Jan. 30, 2025, and entitled “Visual Detection of Crop Rows” and U.S. patent application Ser. No. 19/077,898, filed Mar. 12, 2025, and entitled, “Using Previous Best Fit as Initialiser” (hereby incorporated by reference in its entirety).

While the following disclosure primarily discusses generating a new guidance line, it should be noted that this methodology has broader application and may, for example, also be used to store a series of offsets or nudges relative to the original guidance line. Thus, where the original guidance line is known (as is often the case), then instead of generating an entirely new guidance line based on the vehicle's pose and the center of the lane and/or rows, as identified, the offsets from the center of the guidance line to the original guidance line may instead by stored. Thus, subsequent operations may reuse the original guidance line in combination with the list of offsets. In some instances, this may be advantageous. For example, this approach may reduce the amount of computation performed by the system. It also provides additional information on the quality of the original steering system with regards to how well the planter follows the desired path/original guidance line as driven by the tractor.

### Augmenting Existing Operations

According to one aspect, one option for the generation of the proposed guidance line is to augment existing field operations in such a way as to allow the field operation to continue normally and to generate a guidance line that may then be used for subsequent operations. Such an approach is advantageous as it may reduce the expense for the farmer since the field operation was already going to happen and such an approach may further reduce expenses by reducing the cost of future operations as they would no longer need specialized sensor suites to allow for autonomous steering.

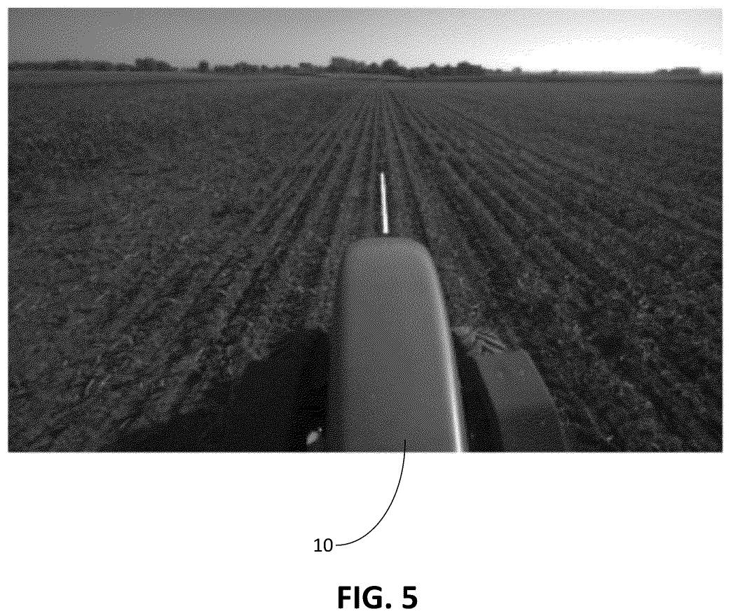

For example, if a color or depth camera (e.g. stereographic, time-of-flight, lidar, or other type of cameras.) is attached to a tractor that is cultivating a field at early growth stages where the lanes between the rows of crop are still clearly visible, as shown in FIG. 5, then the guidance lines for that field may be generated based on the actual position of the crops and be used later in the season when the lanes are no longer visible. Thus, complex sensor suits are no longer needed for subsequent operations.

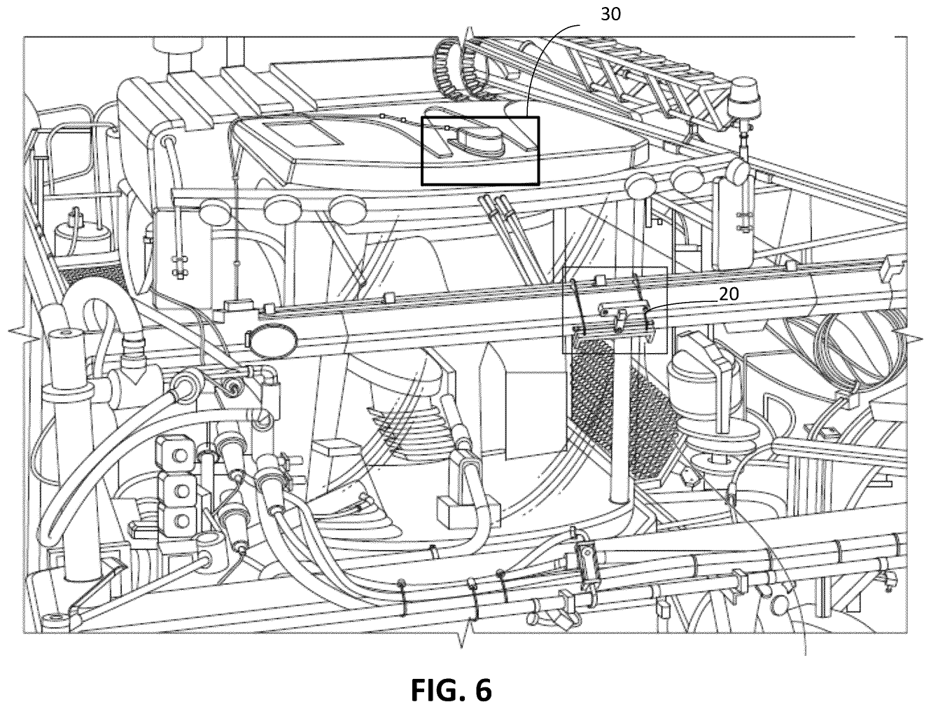

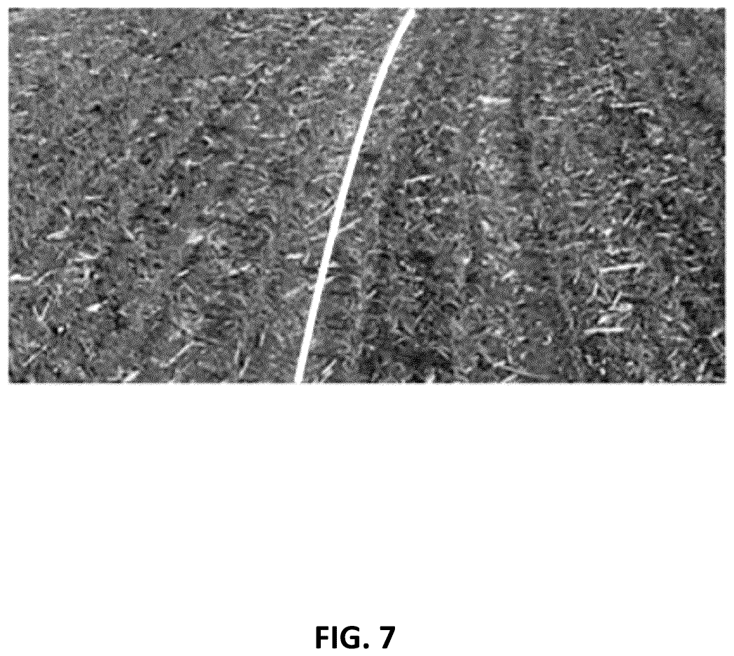

FIG. 6 illustrates an example of an agricultural vehicle in the form of a sprayer which has a GPS receiver 30 and a stereographic camera 20 mounted thereon. FIG. 7 illustrates an example of a guidance line generated between two rows of corn.

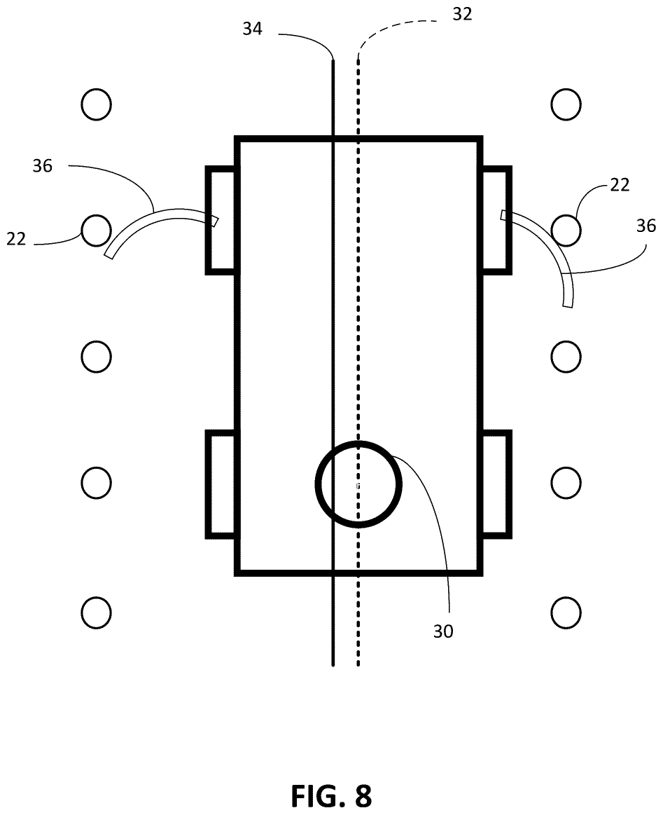

There are various options for the generation of the guidance line based on the current vehicle pose. One is to record the position of the vehicle during the period of autonomous steering provided by the sensor suite used to steer between crop rows. While this may provide a usable guidance line and helps provide repeatability of steering in subsequent operations, if the vehicle is steering slightly off from the true center of the row (if the vehicle's cross-track error is non-zero) then the non-zero error may be recorded as the guidance line and future operations may also steer off from the true center of the row. A pictorial representation of this methodology is shown in FIG. 8 where mechanical row feelers 36 associated with a vehicle are used to detect the presence of plants 22. A GPS 30 is mounted to the vehicle 10. As shown, the vehicle 10 steers along a guidance line 32 which is slightly off from the actual center of the lane 34.

It may be advantageous to identify the true center of the row either using a vision system as discussed on in the column based methodology of U.S. patent application Ser. No. 19/041,825, and generating a guidance line off of those positions as discussed by U.S. patent application Ser. No. 19/057,707, filed Feb. 19, 2025, and entitled, “Projecting Pixels onto Terrain”. Similarly, if one were using a sensor suite that reports the vehicle's deviation from the center of the lane (e.g. mechanical wands attached to either side of a sprayer's wheels) then the vehicle pose may be used to geolocate the center of the row and that position may be stored for use in generating the guidance line.

It should be noted that, if the center of the lane is being geolocated based on the cross-track error (XTE) provided by some sensor directly attached to the vehicle's wheels, then the specific calculations discussed in U.S. patent application Ser. No. 19/057,707, (Projecting Pixels onto Terrain) are not generally applicable since those are performed based on a conversion of camera space into navigation space. Instead, the position of the center of the lane may be calculated using rigid-body dynamics. This may be expressed as:

p_{w}=pᵥ+R_{nb}r_{vw}

where p_{w} represents the position of the wheel in navigation space, pᵥ is the position of a known point on the vehicle in navigation space, R_{nb} is a rotation matrix based on the vehicle roll, pitch, and yaw and r_{vw} is a vector from the known position of the vehicle (e.g. at the GPS or control unit) to the wheel. Then, taking the offset from the wheel based on the reported cross-track error, the location of the center of the lane, pie, can be put in navigation space by doing the following

pₖ=pₓ+XTE.

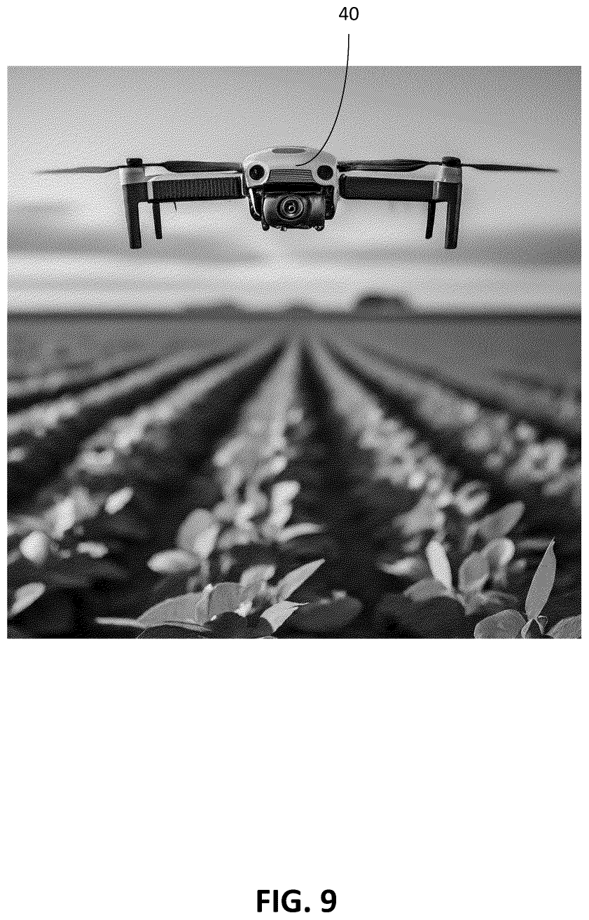

It should also be noted that the methodology discussed in U.S. patent application Ser. No. 19/057,707, (Projecting Pixels onto Terrain) is not restricted to terrestrial vehicles. Thus, if an unmanned aerial vehicle (U AV) were to be used to check crop health, validate emergence, or check stalk count, the same methodology may be applied to generate a guidance line from the crop rows as they are identified as shown in FIG. 9. In FIG. 9, an aircraft in the form of an UAV 40 is shown above a crop. The UAV may have one or more cameras as well as a GPS receiver. The GPS receiver is a positioning sensor which may be used to determine the position and orientation of the UAV in the field. At least one crop detection sensor such as at least one camera may be used to determine locations associated with crop rows in the field relative to the UAV. Similarly, if an agricultural aircraft were to be used to apply fertilizer or pesticides, the same process may be used provided the position of the vehicle is known.

### Operation Specifically for Mapping

The benefits of having a reliable guidance line that may be shared for use in subsequent field operations is so significant, that in some instances it may benefit farmers to run a separate operation for the purpose of mapping the crops, as planted, and generating a guidance line for all future operations in that season. The separate operation would not perform a field operation on the crop but may be used solely for mapping

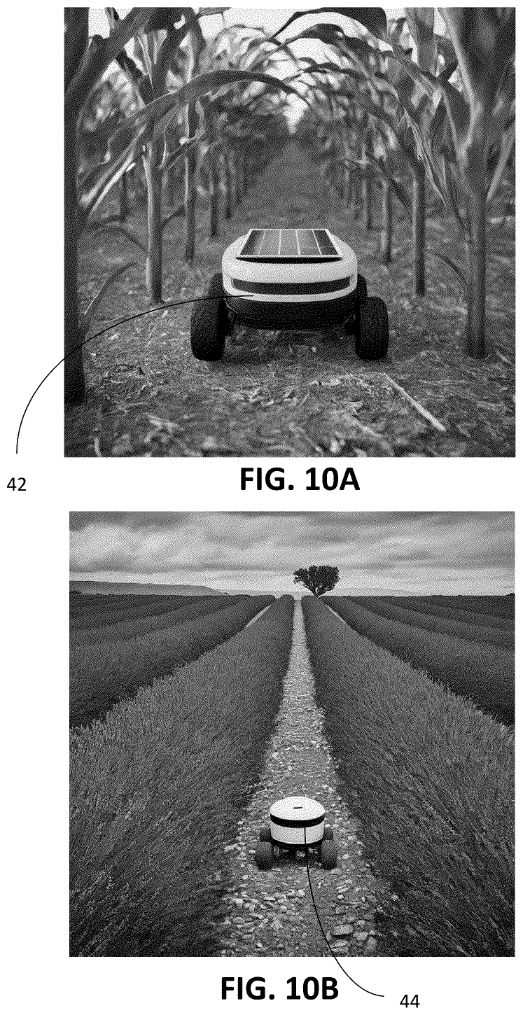

Doing so does not require sensor fusion or machine learning methods to combine the vehicle pose with the center of the lane (or the center of the rows), as identified to generate a guidance line. However, for these cases, a smaller autonomous vehicles may be used to conduct the operation since there is no need to run any additional operation at the time. Thus, small scale autonomous robots or drones or other unmanned ground vehicles (UGVs) may be used to conduct the mapping operation, as shown in FIG. 10A as a first UGV vehicle 42 shown between two rows of corn. FIG. 10B shows a second UGV vehicle 44 between two rows of lavender.

In some instances, such a vehicle may provide for additional monitoring of crops or collect other data while performing the mapping operation but without performing a typical field operation such as spraying, cultivating, harvesting, etc. These ancillary monitoring functions could include pest detection using high-resolution cameras to identify insect presence or damage patterns on plants. The UGV may also assess early disease symptoms through multispectral imaging that can detect changes in plant tissue before they become visible to the human eye. Soil moisture monitoring sensors can provide field-specific data on water content at various depths, helping to optimize irrigation schedules. Plant growth stage assessment can be performed through measurements of plant height, stem diameter, and leaf development to track crop progress against expected growth curves. Nutritional deficiency detection through specialized cameras that analyze leaf coloration patterns can identify areas requiring targeted fertilizer application. Weed identification and mapping can be accomplished to create precision treatment maps for subsequent spraying operations. Stand count evaluation can verify germination success and plant population density. Additionally, canopy coverage analysis can determine the percentage of ground shaded by plant foliage, which correlates with photosynthetic capacity and weed suppression. One or more of these monitoring functions may be performed simultaneously with the guidance line mapping, increasing the value of the dedicated mapping operation while still maintaining the primary focus on generating accurate guidance lines for future field operations.

These types of systems may provide additional benefits since they may be completed before the first large operation in the field, thereby helping to ensure that every operation after planting has a high quality guidance line to be used for steering. This improves over the previously described scenario wherein the first operation would not have the high quality guidance line and would likely have worse steering performance than subsequent operations (after the guidance line has been generated). If the guidance line is being generated real time and is never improved/smoothed after the fact then this would not be the case. However, if any additional post-processing is performed on the guidance line then generating the guidance line beforehand is beneficial.

Conversely, running such an operation solely or primarily for the purposes of generating a guidance line would incur an additional expense and would require additional field time as compared with generating the guidance line during a field operation that was already scheduled. As previously mentioned, additional monitoring operations may be performed simultaneously with the generation of guidance data which may further be considered in evaluating tradeoffs to generating a guidance line in this way. Thus, different situations or environments or economic analysis may result in preference for one approach or the other with respect to the generation of guidance data.

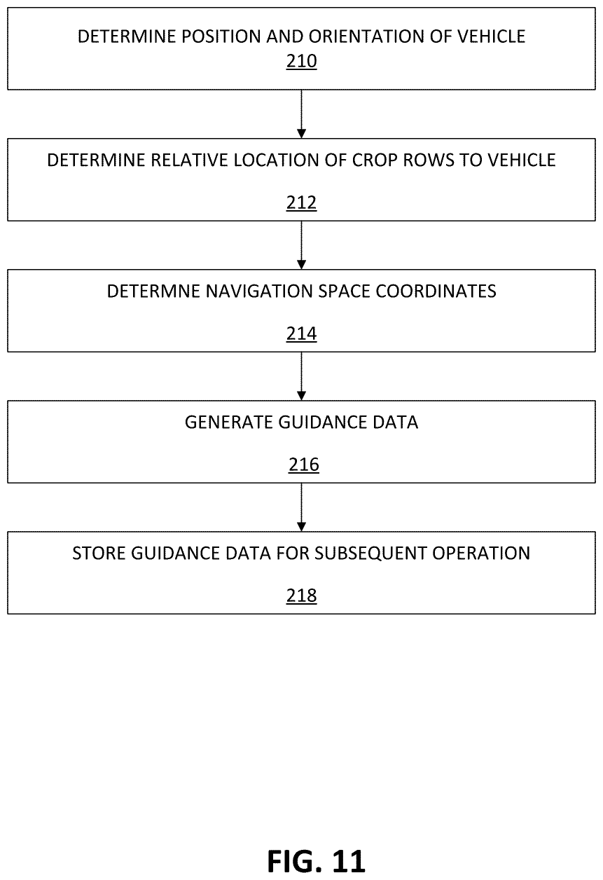

FIG. 11 is a flow chart illustrating one example of a method for generating guidance data. In step 210, the position and orientation of the vehicle is determined. For example a GPS, IMU, or combinations thereof may be used to determine position and orientation. Next in step 212, a relative location of crop rows to the vehicle is determined. This may be determined using at least one crop detector sensor. Example crop detectors may include cameras or other imaging devices. Next in step 214, navigation space coordinates may be determined for points associated with the crop rows by combining the position and orientation of the agricultural vehicle with the locations associated with the crop rows in the field relative to the agricultural vehicle. It is to be understood that locations associated with the crop rows may be the crop rows themselves or a center line between adjacent crop rows. Next in step 216, guidance data is generated based on the navigation space coordinates. The guidance data may be, for example, guidance lines or offsets or other corrections to an original guidance line or other types of guidance data. Then in step 218, the guidance data is stored for use in subsequent operation.

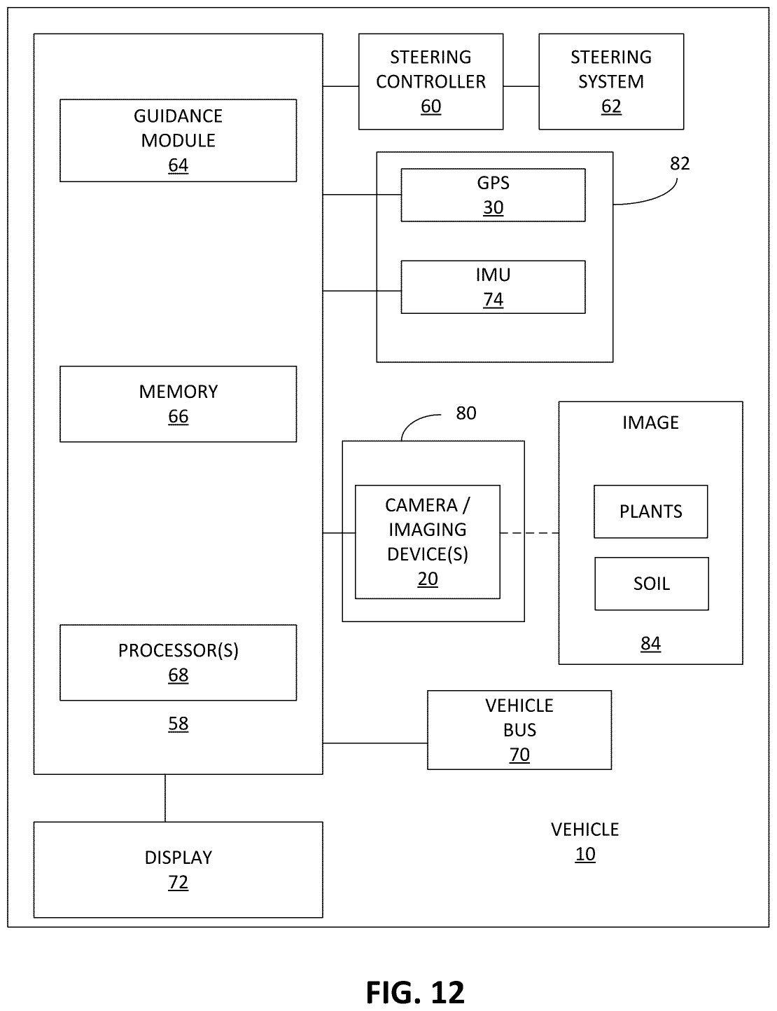

FIG. 12 is a block diagram illustrating one example of a system associated with a vehicle 10. A control system 58 is shown which may include at least one processor 68. At least one memory 66 may be in operative communication with the at least one processor 68. The memory 66 may be a non-transitory machine readable memory may be used to store instructions to be executed by the at least one processor 68. Any number of different modules may also be present such as a guidance module 64. The guidance module 64 may be in operative communication with a steering controller 60 which may be operatively connected to a steering system 62 to allow for automated steering.

At least one positioning sensor 82 may also be present. Examples may include, but art not limited to a GPS receiver 30 and an IMU 74. At least one crop detection sensor 80 may also be present. Examples include but are not limited to cameras, depth cameras, time-of-flight cameras, or other imaging devices 20. Where such devices are used then images 84 of plants and/or soil may be captured. However, the crop detection sensor 80 may also be mechanical in nature or as otherwise described herein. A display 72 is operatively connected to the control system or processing system 58 to provide feedback to an operator of the vehicle 10. A vehicle bus 70 may also be operatively connected to the control system 58. In some embodiments the vehicle bus 70 is used to communicate between different system components.

The at least one positioning sensor 82 may be mounted on the agricultural vehicle 10 and configured to determine a position and orientation of the agricultural vehicle 10. The at least one crop detection sensor 80 may be mounted on the agricultural vehicle 10 and configured to detect positions of crop rows relative to the agricultural vehicle 10. The control system or processing system 58 may be communicatively coupled to the at least one positioning sensor 82 and the at least one crop detection sensor 80 and configured to receive position and orientation data from the at least one positioning sensor 82, receive crop row position data from the at least one crop detection sensor 80, calculate navigation space coordinates of points along the crop rows by combining the position and orientation data with the crop row position data, and generate guidance data based on the calculated navigation space coordinates, and then store the guidance data in a storage device. The storage device may be the memory 66 or may be a storage device which is external to or remote from the processing system 58.

### Additional Advantages

Various advantages associated with the present disclosure have been described, but one skilled in the art having the benefit of this disclosure will appreciate that additional advantages are present as may be applicable to particular situations.

Harvesting damaged/downed corn. If there is a windstorm or hail damage, corn plants may be partially flattened. However, some of the cars of corn may still be salvageable if the corn plants are harvested. In this scenario, using row feelers on a combine may be difficult or even impossible. If a guidance line had been generated earlier in the season (before the crops were damaged) then that guidance line may be used to steer down the rows of corn even when those same rows cannot be identified otherwise.

Custom Applicators. Many farmers do not own their own sprayers and, instead, contract out spraying operations to third party applicators. This may result in inconsistent results between operators since they are not sharing a guidance line. If the custom applicator generates a guidance line or one is provided to the custom applicator, that may improve results and reduce crop damage associated with the spraying operations. Alternatively, the custom applicator may provide a service wherein the custom applicator sprays the field, as usual, and then provides an accurate series of guidance lines to the farmer which could then be used during future spraying operations and during the harvest season or other subsequent operations.

Reducing Wear and Tear. If the mapping is conducted sufficiently early in the season (i.e. before canopy), then the mechanical row feelers would not be necessary at any point in the season. Since mechanical row feclers work by physically hitting corn stalks, they are subject to wear and tear requiring that they be replaced on a semi-regular basis. The mechanical row feelers on a combine head are often angled slightly toward the cabin of the combine to reduce the overall wear and tear on them. However, if they have already passed a plant and then the vehicle is backed up for any reason (e.g. to line up with the row or to move over by one row) the wands may sometime break. However, as previously discussed there is no need for the mechanical row feelers if reliable guidance line are used instead. In these cases, not needing the wands would already be a cost savings for the farmer but not needing to replace them presents an additional and ongoing savings.

Therefore various embodiments, options, and alternatives have been discussed. The present disclosure encompasses a method for generating a new guidance line for vehicle navigation using a known vehicle pose determined through various sensors such as GPS, IMU, and/or cameras, along with the location of a desired guidance line based on lane centers, crop row centers, or vehicle position offsets. This guidance line generation may occur during a dual-use operation where a previously planned operation is augmented to enable guidance line creation. The location of the guidance line may be calculated using depth information from depth cameras, LIDAR systems, ultrasonic sensors, or other depth measuring devices.

Alternatively, points of the desired guidance line can be calculated based on known crop row positions detected via contact or non-contact sensors including row feelers, ultrasonic sensors measuring distance to crops, or camera systems. The system may utilize the vehicle's cross-track error (XTE) to compute points of the desired guidance line, or may simply use the current vehicle location to compute guidance line points without requiring an offset.

In another embodiment, given a known vehicle pose, desired guidance line location, and original guidance line location, the system can generate a series of offsets to the original guidance line for subsequent operations. These offsets may be calculated during a dual-use operation, using depth information from various sensors, based on known crop row positions, using the vehicle's XTE, or using the current vehicle location without further modification.

The present disclosure provides for implementations with guidance lines generated from cameras mounted on vehicles, sprayers, or aerial vehicles. The system accommodates both new guidance lines created independently and those derived from original guidance lines with calculated offsets, supporting both dual-use operations where existing tasks are augmented and dedicated operations focused solely on guidance line generation.

As used herein, “an agricultural vehicle in a field” may include an aerial vehicle including an unmanned aerial vehicle (UAV) or aircraft within the airspace over a field as well as a ground-based vehicle which is driving through the field such as a tractor, sprayer, combine, unmanned ground vehicle (UGV), or other vehicle.

As used herein, “navigation space coordinates” refers to a set of coordinates representing positions within a defined reference frame used for vehicle navigation. These coordinates may be expressed in a global reference system (such as latitude/longitude or Universal Transverse Mercator), a local reference system established for a particular field or operation, or a relative reference system that uses a fixed point as its origin. Navigation space coordinates enable the precise localization of points, paths, and objects relative to a navigating vehicle, allowing for consistent mapping, guidance, and autonomous operation across multiple vehicles and time periods.

As used herein, “positioning sensor” may include any device or system that determines the location, orientation, or movement of an agricultural vehicle in a field, including, but not limited to, global positioning system (GPS) receivers, inertial measurement units (IMUs), wheel angle sensors, cameras, time-of-flight cameras, LIDAR units, and any combination thereof.

As used herein, a “crop detection sensor” may include any device that identifies, locates, or measures the position of crop rows relative to an agricultural vehicle, including but not limited to camera systems (color, depth, stereographic, time-of-flight), LIDAR systems, ultrasonic sensors, mechanical row feelers, optical sensors, radar systems, contact sensors, non-contact sensors, and any combination thereof.

As used herein “guidance data” includes information which may be used to direct the movement of an agricultural vehicle during field operations including but not limited to newly generated guidance lines, modified guidance lines, offset values to be applied to existing guidance lines, coordinates of points along crop rows, lane centers, crop row centers, and any data which may be used to determine a path for an agricultural vehicle and/or implement to follow.

It should further be understood that determining locations of crop rows in the field may include directly or indirectly determining the locations of crop rows or locations of center lanes from which the location of crop rows may be determined.

The foregoing disclosure provides illustration and description but is not intended to be exhaustive or to limit the implementations to the precise form disclosed. Modifications may be made in light of the above disclosure or may be acquired from practice of the implementations. As used herein, the term “component” or “module” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code, it being understood that software and hardware may be used to implement the systems and/or methods based on the description herein. Although particular combinations of features are recited in the claims and/or disclosed in the specification, these combinations are not intended to limit the disclosure of various implementations. In fact, many of these features may be combined in ways not specifically recited in the claims and/or disclosed in the specification.

Although each dependent claim listed below may directly depend on only one claim, the disclosure of various implementations includes each dependent claim in combination with every other claim in the claim set. No element, act, or instruction used herein should be construed as critical or essential unless explicitly described as such. Also, as used herein, the articles “a” and “an” are intended to include one or more items and may be used interchangeably with “one or more”. Further, as used herein, the article “the” is intended to include one or more items referenced in connection with the article “the” and may be used interchangeably with “the one or more”. Furthermore, as used herein, the term “set” is intended to include one or more items (e.g., related items, unrelated items, a combination of related and unrelated items, and/or the like), and may be used interchangeably with “one or more”. Where only one item is intended, the phrase “only one” or similar language is used. Also, as used herein, the terms “has”, “have”, “having”, or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or”, unless explicitly stated otherwise (e.g., if used in combination with “either” or “only one of”).

Where processes include a set of steps it is to be understood that the steps do not necessarily need to be performed in the order provided unless context expressly requires it in order for the process to be operational.

It is also to be understood that various features from different embodiments may be combined. It is to be further understood that various features may be described within particular embodiments, but that certain features or methods may function independently with broader application than to the specific embodiments described.

The disclosure is not to be limited to the particular aspects described herein. In particular, the disclosure contemplates numerous variations. The foregoing description has been presented for purposes of illustration and description. It is not intended to be an exhaustive list or limit any of the disclosure to the precise forms disclosed. It is contemplated that other alternatives or exemplary aspects are considered included in the disclosure. The description is merely examples of aspects, processes, or methods of the disclosure. It is understood that any other modifications, substitutions, and/or additions may be made, which are within the intended spirit and scope of the disclosure.

What is claimed is:

1. A method for generating agricultural guidance data, the method comprising:
determining a position and orientation of an agricultural vehicle in a field using at least one positioning sensor;
determining locations of crop rows in the field relative to the agricultural vehicle using at least one crop detection sensor;
calculating navigation space coordinates of points associated with the crop rows by combining the position and orientation of the agricultural vehicle with the locations associated with the crop rows in the field relative to the agricultural vehicle;
generating guidance data based on the calculated navigation space coordinates; and storing the guidance data for use in a subsequent agricultural operation.

2. The method of claim 1, wherein:
the agricultural vehicle is performing a primary agricultural operation while the guidance data is being generated; and
the subsequent agricultural operation is performed at a later growth stage of the crops.

3. The method of claim 2 wherein the primary agricultural operation is performed during a pre-canopy growth stage and wherein the later growth state is a post-canopy growth stage.

4. The method of claim 1, wherein the at least one crop detection sensor includes a camera system configured to identify visual boundaries between crop vegetation and soil.

5. The method of claim 1, wherein calculating the navigation space coordinates comprises:
determining a cross-track error between the agricultural vehicle and centers of lanes between crop rows; and
applying the cross-track error to the position and orientation of the agricultural vehicle.

6. The method of claim 1 further comprising using the guidance data in the subsequent agricultural operation.

7. The method of claim 1, wherein:
an original guidance line used during planting of the crops is available; and
generating the guidance data comprises calculating offset values between the original guidance line and the calculated navigation space coordinates of the crop rows.

8. The method of claim 7, wherein the guidance data includes:
the original guidance line; and
a series of georeferenced offset values to be applied to the original guidance line during the subsequent agricultural operation.

9. The method of claim 1 wherein the agricultural vehicle is selected from a set consisting of an unmanned aerial vehicle and an unmanned aerial vehicle.

10. The method of claim 1 wherein the determining locations of crop rows comprises at least one of identifying centers of crop rows and identifying centers of lanes between crop rows.

11. A method for providing guidance data between agricultural operations comprising:
during a first agricultural operation after planting:
determining a position and orientation of a first agricultural vehicle,
detecting actual positions of crop rows or lanes therebetween using at least one sensor mounted on the first agricultural vehicle,
determining guidance data using the position and orientation of the first agricultural vehicle and the actual positions of crop rows or lanes therebetween; and
during a second agricultural operation:
retrieving the guidance data, and
guiding a second agricultural vehicle using the guidance data.

12. The method of claim 11, wherein:
the first agricultural operation is performed during a pre-canopy growth stage when soil is visible between crop rows; and
the second agricultural operation is performed during a post-canopy growth stage.

13. The method of claim 11, wherein detecting the actual positions of crop rows or lanes therebetween comprises:
capturing image data using at least one camera mounted on the first agricultural vehicle;
processing the image data to identify boundaries between crop vegetation and soil; and
calculating centers of lanes between identified crop vegetation.

14. A system for generating agricultural guidance data, the system comprising:
at least one positioning sensor mounted on an agricultural vehicle and configured to determine a position and orientation of the agricultural vehicle;
at least one crop detection sensor mounted on the agricultural vehicle and configured to detect positions of crop rows relative to the agricultural vehicle; and
a processing system communicatively coupled to the at least one positioning sensor and the at least one crop detection sensor, the processing system configured to:
receive position and orientation data from the at least one positioning sensor,
receive crop row position data from the at least one crop detection sensor,
calculate navigation space coordinates of points along the crop rows by combining the position and orientation data with the crop row position data,
generate guidance data based on the calculated navigation space coordinates, and store the guidance data in a storage device.

15. The system of claim 14, wherein the at least one crop detection sensor comprises a stereographic depth camera configured to:
capture three-dimensional depth information of a field; and
identify crop rows based on height differences between crop vegetation and soil.

16. The system of claim 14, wherein the agricultural vehicle is configured to perform a primary agricultural operation while the processing system generates the guidance data.

17. The system of claim 14, wherein the processing system is further configured to:
compare the calculated navigation space coordinates with an original guidance line used during planting of the crops; and
generate the guidance data as a series of offset values between the original guidance line and the calculated navigation space coordinates.

18. The system of claim 14, wherein the at least one crop detection sensor comprises a camera system configured to identify visual boundaries between crop vegetation and soil.

19. The system of claim 14, wherein the at least one positioning sensor includes a global positioning system (GPS) receiver and an inertial measurement unit (IMU).

20. The system of claim 14, wherein the processing system is further configured to determine cross-track error between the agricultural vehicle and centers of lanes between crop rows, and to apply the cross-track error to the position and orientation data when calculating the navigation space coordinates.
